(19) United States
(12) Patent Application Publication
(10) Pub. No.: US 2026/0298771 A1
(43) Pub. Date: Oct. 1, 2026

(54) SYSTEM INCLUDING A GEAR AND A TESTING MACHINE

(71) Applicant: SEW-EURODRIVE GMBH & CO. KG, Bruchsal (DE)

(72) Inventors: Zili WU, Tianjin (CN); Lech BANASIK, Brighton East (AU)

(73) Assignee: SEW-EURODRIVE GMBH & CO. KG, Bruchsal (DE)

(21) Appl. No.: 19/475,826

(22) PCT Filed: Feb. 28, 2024
(86) PCT No.: PCT/EP2024/055141

§ 371 Date: Oct. 16, 2025

(30) Foreign Application Priority Data
Apr. 17, 2023 (CN) 202310413381.5
May 31, 2023 (DE) 10 2023 002 219.5

(51) Int. Cl. G01M 13/025; G01M 13/021

(52) U.S. Cl. CPC G01M 13/025; G01M 13/021

(57) ABSTRACT

A system that includes a gear and a testing machine, which includes a turntable that can be rotated by an electric drive, a first linear axis, a second linear axis, a pinion connected in a rotationally fixed manner to a shaft, and a second drive. Brackets are connected in a rotationally fixed manner to the turntable, the gear is connected to the turntable in a rotationally fixed manner via the brackets, and the pinion is engaged with the gear.

### FIELD OF THE INVENTION

The present invention relates to a system that includes a gear and a testing machine.

### BACKGROUND INFORMATION

In certain conventional systems, a linear axis is arranged as a machine element for components that can be displaced along a straight line.

German Patent Document No. 10 2011 011 946 describes a method for measuring and testing a workpiece.

A gear testing machine is described in Chinese Patent Document No. 103969044.

A gear positioning device is described in German Patent Document No. 11 2018 005 472.

A segmented gear rim is described in U.S. Patent Application Publication No. 2014/0208880.

A transmission testing machine is described in Chinese Patent Document No. 213616064.

### SUMMARY

Example embodiments of the present invention provide for making the testing machine capable of testing the gear under operating conditions.

According to example embodiments, in a system that includes a gear and a testing machine, the system includes a turntable that can be rotated by an electric drive, a first linear axis, a second linear axis, a pinion connected in a rotationally fixed manner to a shaft, and a second drive, e.g., for the shaft. Brackets are connected in a rotationally fixed manner to the turntable, and the gear is connected to the turntable in a rotationally fixed manner via the brackets. The pinion is engaged with the gear, e.g., the toothing of the pinion is engaged with the toothing of the gear. The center distance between the gear and the pinion can be controlled via the second linear axis, and the axial position of the pinion in relation to the axial position of the gear can be controlled via the first linear axis. For example, the pinion can be braked via the second drive, or the torque transmitted from the electric second drive of the gear to the pinion via the gear is transmitted to the second drive.

An advantage of this is that the sound generated during the rotary motion of the gear can be monitored via the testing machine. For example, the sound, e.g., structure-borne sound, is detected by a sensor and the signal from the sensor is subjected to a Fourier analysis and the resulting spectrum is monitored for exceedance of a respective threshold value assigned to a frequency range. The testing machine can also be used to monitor other tooth engagement conditions, such as the contact surface during tooth engagement and the play, e.g., flank backlash, of the tooth engagement. In addition, the runout and other parameters for the precision of the gear assembly, e.g., the relative alignment of the segments to each other, can be tested. For this purpose, at least one corresponding sensor is also arranged in the testing machine.

It is also important that the axis of rotation of the gear is oriented vertically, although in real operating conditions, for example, in a cement mill, the gear should be operated with a horizontally oriented axis of rotation.

The operation of the gear is thus intended in a different orientation than in the testing machine, in which the axis of rotation in the intended operation is oriented perpendicular to the axis of rotation of the gear in the testing machine.

According to example embodiments, the shaft has a shaft piece that is connected in a rotationally fixed manner to an adapter shaft via a chuck, which adapter shaft can be set in rotary motion or braked by a second drive, and an electromagnetically actuated brake or clutch is arranged on the second drive. For example, the second drive includes an electric motor, e.g., which is supported on the lower holding arm. An advantage is that the shaft piece with the pinion pushed onto it can be replaced by another shaft piece, and the second drive unit driving the shaft piece does not have to be replaced but can be retained.

According to example embodiments, the gear has segments arranged one behind the other in the circumferential direction, and the segments closest to each other are connected to each other via screws. For example, each segment has a toothed region. An advantage of this is that the gear is segmented and is held in operation by another component, such as a drum, e.g., a cement drum, of a cement mill. Since the testing machine lacks the component fastening the gear, the gear is held in place by a plurality of brackets. The segments are bolted together.

The segments make it possible to produce a large gear with the help of a small gear cutting machine, which finely machines, e.g., mills or grinds, the toothed region of the segment. For example, the gear is larger than the gear cutting machine used.

The gear can also be manufactured on a gear cutting machine that is small relative to the gear.

According to example embodiments, the number of segments is equal to the number of brackets. For example, each segment is fastened to the turntable by at least one of the brackets. An advantage of this is that each segment is held individually with at least one bracket. For example, holding is also improved by the screw connection between the segments.

According to example embodiments, the first linear axis is oriented perpendicular to the second linear axis. An advantage of this is that, on the one hand, the center distance, i.e., the radial position of the pinion, and, on the other hand, the axial position of the pinion relative to the gear can be controlled.

According to example embodiments, the axis of rotation of the pinion is oriented parallel to the first linear axis, e.g., vertically. An advantage of this is that the axial position of the pinion can be adjusted and thus the width of the tooth engagement can also be adjusted.

According to example embodiments, the axis of rotation of the gear is oriented parallel to the first linear axis and/or to the axis of rotation of the pinion, e.g., is oriented vertically. An advantage of this is that the pinion and the gear can be provided with spur gearing.

According to example embodiments, the maximum diameter of the turntable is smaller than the maximum diameter of the gear. An advantage of this is that the gear may be larger than the turntable and thus the would fall off the turntable if the brackets were missing. Via the brackets, the gear can be attached to the turntable, and the axis of the gear is oriented coaxially to the axis of rotation of the turntable.

According to example embodiments, the gear is ring-shaped and/or formed as a gear rim, and the maximum diameter of the turntable is smaller than the clear inside diameter of the gear. For example, the radial distance region covered by the brackets overlaps with the radial distance region covered by the turntable and with the radial distance region covered by the gear. For example, the turntable is radially spaced from the gear. An advantage of this is that the gear, which is arranged as a gear rim, can be precisely assembled from segments because the deviations from the target position and target alignment can be limited to a permissible level via the testing machine.

According to example embodiments, the second linear axis is oriented perpendicular to the axis of rotation of the pinion and perpendicular to the axis of rotation of the gear.

According to example embodiments, with the second linear axis, the pinion can be brought into engagement with the gear. An advantage of this is that the pinion can be positioned radially towards the gear via the second linear axis.

According to example embodiments, the first holding arm and the second holding arm spaced apart from the first holding arm can be moved by the second linear axis, e.g., in a vertical direction. An advantage of this is that the vertical height of the pinion can be adjusted to the vertical position of the gear.

According to example embodiments, a support bearing is received in the second, e.g., lower, holding arm, which support bearing rotatably supports the shaft, and/or a bearing is received in the first holding arm, which bearing rotatably supports the shaft. An advantage of this is that the support bearing is positioned against a step of the second support arm.

According to example embodiments, a sensor, e.g., a structure-borne sound sensor and/or angle sensor, is arranged on the second holding arm and can move with the holding arm, e.g., during movement of the linear axes. An advantage of this is that the values of a physical variable, e.g., structure-borne sound, can be recorded as close as possible to the engagement region.

According to example embodiments, a mandrel region is formed on the second holding arm, which region supports the shaft. An advantage of this is that the shaft is stably mounted.

According to example embodiments, the brackets project radially beyond the turntable, and the region covered by the brackets in the axial direction overlaps with the region covered by the turntable in the axial direction and with the region covered by the gear in the axial direction. An advantage of this is that, despite the size of the gear, it can be tested on the testing machine. For example, the gear can be set in rotary motion by a turntable that is much smaller than the gear.

According to example embodiments, the center distance between the gear and the pinion can be controlled via the linear position of the second linear axis. An advantage of this is that the pinion can be moved towards the gear and brought into engagement.

According to example embodiments, the first linear axis is driven by a first synchronous motor, and/or the second linear axis is driven by a second synchronous motor. An advantage of this is that the linear axis can be brought to the respective intended linear positions, e.g., with high precision.

Further features and aspects of example embodiments of the present invention are explained in more detail below with reference to the appended schematic Figures.

### DETAILED DESCRIPTION

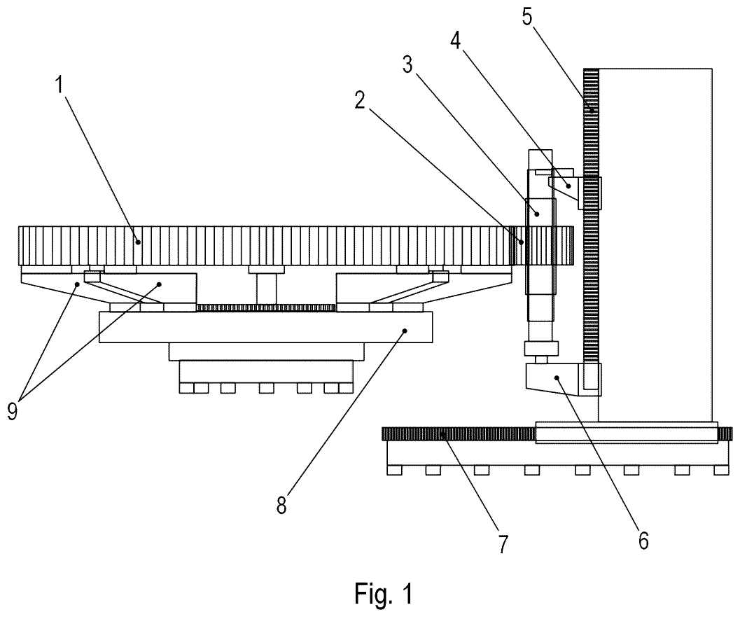

FIG. 1 is a side view of a testing device, e.g., a testing machine, for a segmented gear 1, in which the gear is in engagement with a pinion 2.

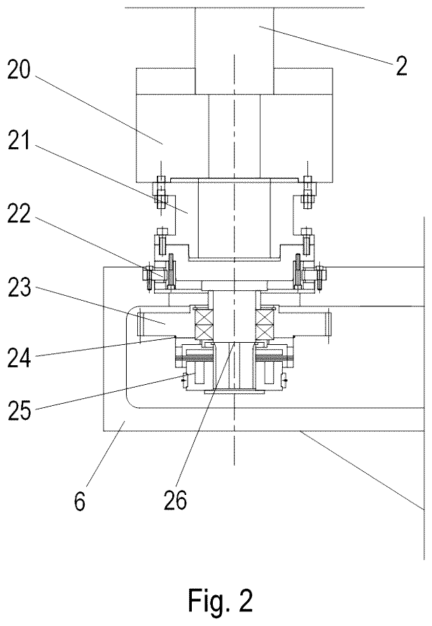

FIG. 2 illustrates a region of the receptacle of the pinion 2.

### DETAILED DESCRIPTION

As illustrated in the Figures, the testing device has a turntable 8 which can be set in rotary motion by an electric drive. The axis of rotation of the turntable 8 is, for example, oriented vertically.

Brackets 9, which hold the segmented gear 1, are mounted on the turntable.

The brackets 9 are detachably connected to both the turntable 8 and the gear 1. The gear 1 is made up of segments that are bolted together.

The segments are arranged one behind the other in a circumferential direction in relation to the axis of rotation of the gear and are connected to each other via tangentially directed screws.

The number of segments of the gear 1 is between five and forty.

Each of the segments has toothing, e.g., spur or helical toothing, on its radially outer circumference.

The axis of rotation of the turntable 8 is oriented coaxially to the axis of rotation of the gear.

Here, the radial direction is always in relation to the axis of rotation of the turntable 8. The axial direction and the circumferential direction are also always related to the axis of rotation of the turntable.

The segments are identical to each other.

The pinion 2, which is in engagement with the gear 1, is driven by the gear 1 and has an axis of rotation oriented parallel to the axis of rotation of the gear 1.

The gear 1 is held via brackets 9 arranged on the turntable 8. The brackets 9 are spaced apart from one another in the circumferential direction, e.g., evenly spaced.

The pinion 2 is connected in a rotationally fixed manner to a shaft piece or the pinion 2 is arranged in one piece, e.g., in one part, with a shaft piece.

For example, the shaft piece is connected in a rotationally fixed manner with a chuck 20 and an adapter flange 21 and is thus referred to below as a multi-part shaft 3.

The shaft 3 is rotatably mounted to two holding arms (4, 6), by which it is also held. The axis of rotation of the shaft 3 is, for example, oriented vertically.

For this purpose, a lower holding arm 6 receives a support bearing 22, which rotatably mounts the shaft 3 and supports it from below. A bearing is also received in the upper holding arm 4, which rotatably mounts the shaft 3.

The two holding arms (4, 6) are arranged to be displaceable via a first linear axis 5.

Thus, the pinion 2 can be displaced linearly via the first linear axis 5, e.g., in a vertical direction.

The first linear axis 5 and thus also the pinion 2 can be displaced, e. g., horizontally, via a second linear axis 7.

The direction of displacement of the first linear axis 5 is, for example, oriented perpendicular to the direction of displacement of the second linear axis 7.

Thus, the center distance between the axis of rotation of the gear and the axis of rotation of the pinion can be controlled via the linear axis 7.

The axes of rotation of gear 1 and pinion 2 are thus parallel.

To test the gear 1, the linear axis 7 is moved such that the pinion 2 is in engagement with the gear 1. The tooth engagement can thus be checked when turning gear 1. Since the gear 1 is composed of segments that are bolted together, the engagement condition can be monitored by the testing device and thus the precision of the connection of the segments can be tested.

The brackets 9 are fastened to the turntable 8 and project radially beyond the turntable 8. Thus, a gear 1 whose diameter is larger than the maximum diameter of the turntable 8 can be tested. Thus, the gear 1 cannot be assembled on the turntable from the segments.

With the vertically aligned linear axis 5, the pinion 2 can be displaced vertically and thus aligned with the gear 1.

The turntable 8 is driven by the electric drive. The pinion 2 is thus driven by the gear 1. In order to achieve a predetermined load during tooth engagement, a drive 23 is provided, which transmits the power supplied from gear 1 to pinion 2.

For example, a synchronous motor can be used as the drive 23, upstream of which a gearbox is connected.

The support bearing 22 is received in the lower holding arm 6 for rotatably receiving the pinion 2.

The drive 23 is arranged below the holding arm 6, i.e., on the side of the holding arm 6 facing away from the support bearing 22.

An angle encoder 24 of a sensor is arranged on the drive 23 so that a value of the angular position of the shaft 3 can be detected with the sensor. The signals from the sensor are fed to a control unit, which generates control signals for the drive 23 and for the electric drive of the turntable 8.

At its end face, which is directed downwards in the direction of gravity, the shaft 3 is supported on a mandrel 26, which is arranged as a support on the one hand and as a centering device on the other. The mandrel 26 is arranged in or on the lower holding arm.

For example, a clutch or brake 25 is arranged below the electric drive 23 in the direction of gravity. Thus, the torque transmission from the shaft 3 to the drive 23 via the clutch or brake 25 can be interrupted, depending on the condition of the clutch or brake 25. In this manner, the load can be suppressed or, respectively, controlled.

A shaft sealing ring is arranged axially next to the support bearing 22, which ring seals the lower holding arm 6 towards the shaft 3.

Each linear axis (5, 7) is, for example, driven by a synchronous motor.

For example, the electric drive of the turntable 8 is motor-driven and the drive 23 is generator-driven. The runout of the gear 1 and other parameters of the gear 1 can be checked quickly and readily. However, with motorized operation of the second drive 23, e.g., and generative operation of the electric drive, i.e., the first drive, a test can be carried out which comes closer to the real operating conditions.

According to example embodiments, the number of segments is equal to the number of brackets 9. Thus, each segment is held by exactly one bracket 9.

### LIST OF REFERENCE NUMERALS

1 Segmented gear
2 Pinion
3 Shaft
4 Upper holding arm
5 Linear axis, vertical
6 Lower holding arm
7 Linear axis, horizontal
8 Turntable
9 Bracket
20 Chuck
21 Adapter shaft
22 Support bearing
23 Drive
24 Angle encoder
25 Clutch or brake
26 Mandrel

1-15. (canceled)

16. A system, comprising:
a gear; and
a testing machine including:
a turntable rotatable by an electric drive;
brackets connected in a rotationally fixed manner to the turntable;
a first linear axis;
a second linear axis;
a pinion connected in a rotationally fixed manner to a shaft; and
a second drive;
wherein the brackets connect the gear to the turntable in a rotationally fixed manner;
wherein the pinion is engaged with the gear;
wherein the second linear axis is adapted to control a center distance between the gear and the pinion;
wherein the first linear axis is adapted to control an axial position of the pinion in relation to an axial position of the gear.

17. The system according to claim 16, wherein a toothing of the pinion is engaged with a toothing of the gear.

18. The system according to claim 16, wherein the second drive is adapted to brake the pinion.

19. The system according to claim 16, wherein the shaft includes a shaft piece connected in a rotationally fixed manner to an adapter shaft via a chuck, and the second drive is adapted to set the adapter shaft in rotary motion and/or to brake the adapter shaft, and an electromagnetically actuated brake and/or clutch is arranged on the second drive.

20. The system according to claim 19, wherein the second drive includes an electric motor.

21. The system according to claim 20, wherein a lower holding arm supports the electric motor.

22. The system according to claim 16, wherein the gear includes segments arranged one behind the other in a circumferential direction, and the segments that closest to each other are connected to each other via screws.

23. The system according to claim 22, wherein each segment includes a toothed region.

24. The system according to claim 22, wherein a number of the segments is equal to a number of the brackets.

25. The system according to claim 24, wherein each segment is fastened to the turntable by at least one of the brackets.

26. The system according to claim 16, wherein the first linear axis is oriented perpendicular to the second linear axis.

27. The system according to claim 16, wherein an axis of rotation of the pinion is oriented parallel to the first linear axis and/or an axis of rotation of the gear is oriented parallel to the first linear axis and/or to the axis of rotation of the pinion.

28. The system according to claim 16, wherein (a) a maximum diameter of the turntable is smaller than a maximum diameter of the gear and/or (b) the gear is ring-shaped and/or arranged as a gear rim and the maximum diameter of the turntable is smaller than a clear inside diameter of the gear.

29. The system according to claim 28, wherein a radial distance region covered by the brackets overlaps with a radial distance region covered by the turntable and with a radial distance region covered by the gear and/or the turntable is radially spaced from the gear.

30. The system according to claim 16, wherein the second linear axis is oriented perpendicular to an axis of rotation of the pinion and perpendicular to an axis of rotation of the gear and/or the second linear axis is adapted to bring the pinion and the gear into engagement.

31. The system according to claim 16, wherein the second linear axis is adapted to move a first holding arm and a second holding arm spaced apart from the first holding arm.

32. The system according to claim 31, wherein a support bearing received in the second holding arm and/or a bearing received in the first holding arm rotatably supports the shaft.

33. The system according to claim 31, wherein a sensor, a structure-borne sound sensor, and/or an angle sensor is arranged on the second holding arm and is movable with the holding arm.

34. The system according to claim 31, wherein a mandrel region arranged on the second holding arm supports the shaft.

35. The system according to claim 16, wherein the brackets project radially beyond the turntable and a region covered by the brackets in an axial direction overlaps with a region covered by the turntable in the axial direction and with a region covered by the gear in the axial direction.

36. The system according to claim 16, wherein the second linear axis is adapted to control a center distance between the gear and the pinion.

37. The system according to claim 16, wherein a first synchronous motor is adapted to drive the first linear axis and/or a second synchronous motor is adapted to drive the second linear axis.
